(19) United States
(12) Patent Application Publication
(10) Pub. No.: US 2015/0127442 A1
(43) Pub. Date: May 7, 2015

(54) SYSTEMS AND METHODS FOR STORING USER DISCOUNT CARDS WITH A PAYMENT ACCOUNT FOR FUTURE PURCHASES

(71) Applicant: Kent Christopher Griffin, Mountain View, CA (US)

(72) Inventor: Kent Christopher Griffin, Mountain View, CA (US)

(21) Appl. No.: 14/071,980

(22) Filed: Nov. 5, 2013

(51) Int. Cl. G06Q 20/38; G06Q 30/02

(52) U.S. Cl. CPC G06Q 20/387; G06Q 30/0222
USPC 705/14.23; 705/39

(57) ABSTRACT

There is provided systems and method for storing discount cards with a payment account for future purchases. A user may visit a merchant location and purchase goods. During purchase of the goods, the user may utilize a user device to perform a payment using a user account. In other embodiments, the user may provide the merchant with a user account identifier, or other information for identification of the user account. In addition, the user may provide a discount card to the merchant, where the discount card offers rewards to the user on use with the merchant. Discount card information may be stored with a payment provider corresponding to the user account. Thus, when the user pays with the user account at the merchant in the future, the discount card information may be automatically populated.

### TECHNICAL FIELD

Example embodiments of the present application relate generally to storing user discount cards with a payment account for future purchase, and more specifically to storing user discount cards with a user account on purchase of items with a merchant so future purchases using the user account at the merchant will utilize the discount card.

### BACKGROUND

Merchants may offer discount cards, including loyalty card, to users for use with purchasing goods at the merchant. The discount card may entitle the user to savings at the merchant, such as reduced price to “valued customers,” if the user provides the merchant with some basic information and presents the discount card at future visits with the merchant. Additionally, some discount cards may offer customers who spend a certain threshold of money, visit the merchant a specific number of times, or purchase a certain quantity of goods, additional savings or free merchandise. Merchants may additionally offer payment for items through payment information unique to the user, such as a credit/debit card, financial account, and/or user account with a payment service. However, the merchant may require only basic information from the user when establishing the card and in some cases may simply give the user a card with a unique identification number. Thus, the merchant may be unaware the user possesses a discount card based solely on the unique payment information of the user. Therefore, if the user fails to bring the card with the user to the merchant, the user may fail to receive savings from the merchant and may not receive credit for purchases with the merchant.

### BRIEF DESCRIPTION OF THE DRAWINGS

FIG. 1 is a block diagram of a networked system suitable for implementing the process described herein, according to an embodiment;

FIG. 2A is an exemplary system for storing a user discount card with a payment account for future purchases, according to an embodiment;

FIG. 2B is an exemplary system showing transmission of a stored user discount card to a merchant for use with a purchase, according to an embodiment;

FIG. 3 is a flowchart of an exemplary process for storing user discount cards with a payment account for future purchases, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that store user discount cards with a payment account for future purchases. Systems suitable for practicing methods of the present disclosure are also provided.

In various embodiments, a user may visit a merchant location to purchase items from the merchant. Merchants may correspond to grocery stores, clothing department stores, food vendors, or any other merchant offering discount cards. The user may sign up, or previously have signed up, for a discount card with the merchant while purchasing items. On checkout of the items, the user may present the discount card and to receive discounts to which the user is entitled. Additionally, the user may attempt to pay for the items using a payment account. In various embodiments, the payment account may correspond to a user financial account, a user credit/debit card account, and/or a user account with a payment provider. In some embodiments, one or more payment accounts may be linked to each other through shared account information. For example, a credit card may be linked to a user account with a payment provider.

The user may set up a user account with a payment provider. The user account may include information corresponding to the user's financial account(s) enabling payment for items through the payment provider using the financial account(s). Additionally, the user may have a user device including information identifying the user with the user account. For example, the user may install a payment application or other financial application possessing login information, cookies, or other identifiers for the user account. The user device may include user information capable of matching the user device with the account.

Thus, on payment for the items at the merchant, the user may present a user account identifier corresponding to one or more payment accounts. The discount card of the user may be transmitted to the payment provider with the user account identifier. The discount card information may then be stored with the payment account by the payment provider. When the payment account is used for future purchases at the merchant, for example, by presenting the user account identifier for purchase of goods during a future transaction, the payment provider may retrieve the discount card information. The payment provider may then transmit the information to the merchant, or may recalculate the purchase price for the items based on the discount card information and send an updated total with the discount card information to the merchant.

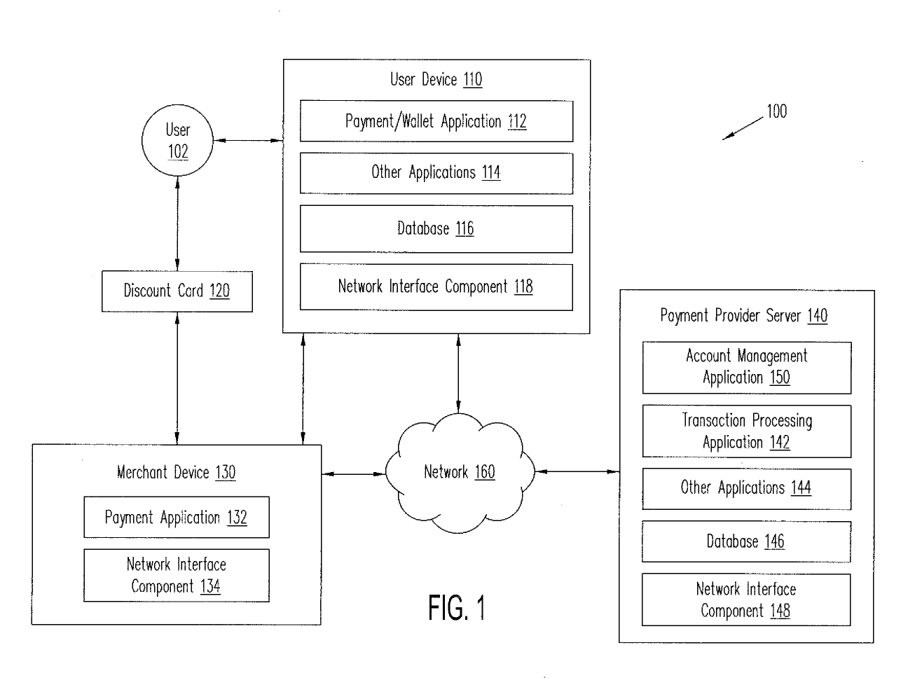

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a discount card 120, a merchant device 130, and a payment provider server 140 in communication over a network 160. User 102, such as a consumer, may utilize user device 110 to present payment for items with merchant device 130. Additionally, user 102 may utilize discount card 120 to receive item discounts or other potential rewards for the purchase of the items. User device 110 and/or merchant device 130 may transmit discount card 120 to payment provider server 140 for use with a future purchase. Thus, payment provider server 140 may transmit information for discount card 120 back to user device 110 and/or merchant device 130 during the future purchases.

User device 110, merchant device 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with merchant device 130 and/or payment provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a payment/wallet application 112, other applications 114, a database 116, and a network interface component 118. Payment/wallet application 112 and other applications 114 may correspond to processes, procedures, and/or applications executable by a hardware processor, for example, a software program. In other embodiments, user device 110 may include additional or different software as required.

Payment/wallet application 112 may be used, for example, to provide a convenient interface to permit user 102 to select payment options and provide payment for items (e.g. goods and/or services). For example, payment/wallet application 112 may be implemented as an application having a user interface enabling the user to enter payment options for storage by user device 110, provide payment on checkout of an item with merchant device 130, and complete a transaction for the item with merchant device 130 and/or payment provider server 140. In certain embodiments, payment/wallet application 112 may correspond more generally to a web browser configured to view information available over the Internet or access a website corresponding to a payment provider. Payment/wallet application 112 may utilize user financial information, such as a credit card, bank account, or other financial account. Additionally, payment/wallet application 112 may provide payment for items using a user account with the payment provider, such as payment provider server 140. Payment/wallet application 112 may include cross-linking, allowing user 102 to identify a user account through an identifier for a separate user account (e.g. identifying a user account through a debit card account number). Payment/wallet application 112 may further include options to store transaction histories for purchased items, such as receipts, for later use. Thus, payment/wallet application 112 provides an interface enabling user 102 to provide proof of purchase of an item to a merchant.

Payment/wallet application 112 may additionally communicate discount card information for discount card 120 to payment provider server 140. Additionally, payment/wallet application 112 may retrieve information for discount card 120 from payment provider server 140 for use with merchant device 130. For example, user 102 may utilize discount card 120 when purchasing items from merchant device 130. User 102 may then utilize payment/wallet application 112 to pay for the items with merchant device 130, for example, by transmitting payment information to merchant device 130. In certain embodiments, the payment information may include a user account identifier, such as a user identifier for user 102, a user credit or debit card number, a user account name, and/or a user account number. However, in other embodiments, the payment information may correspond to a payment transaction receipt from payment provider server 140 corresponding to a completed payment request for the items.

During completion of the payment request with merchant device 130, payment provider server 140 may receive discount card information for discount card 120. For example, payment provider server 140 may receive the payment request from user device 110 and/or merchant device 130. The payment request may include the user account identifier enabling payment provider server 140 to identify a user account for user 102. Additionally, the payment request may be transmitted with discount card information. Payment provider server 140 may store the discount card information with the user account. In various embodiments, the discount card information may further identify a corresponding merchant (the merchant corresponding to merchant device 130).

During future transactions, user 102 may again utilize payment/wallet application 112 to complete a transaction with merchant device 130. Again, a user account identifier corresponding to a user account of user 102 may be transmitted to payment provider server 140. Payment/wallet application 112 may transmit the user account identifier with a payment request received from merchant device 130. Payment provider server 140 may then determine the discount card information corresponding to merchant device 130 and transmit the discount card information to user device 110 and/or merchant device 130 for use with the transaction. Payment provider server 140 may identify the correct discount card information through the received payment request, for example, through an embedded merchant identifier in the payment request, by identifying the sender of the payment request, and/or by receiving a merchant identification from user device 110 and/or merchant device 130. In various embodiments, the discount card information may be used to determine a new payment requests with a new monetary cost of the item(s). However, in other embodiments, payment provider server 140 may determine a reduced cost of the item(s) with merchant device 130 based on the discount card information and transmit a reduced cost payment to user device 110 and/or merchant device 130 with the discount card information.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 140, or other types of applications. Other applications 114 may also include email, texting, voice and IM applications that allow a user to send and receive emails, calls, texts, and other notifications through network 140. In various embodiments, other applications 114 may include financial applications, such as banking, online payments, money transfer, or other applications associated with payment provider server 140. Additionally, other application may include browser applications, social media applications, and/or mapping/check-in applications. Other applications 114 may contain other software programs, executable by a processor, including a graphical user interface (GUI) configured to provide an interface to the user.

User device 110 may further include database 116 which may include, for example, identifiers such as operating system registry entries, cookies associated with payment/wallet application 112 and/or other applications 114, identifiers associated with hardware of user device 110, or other appropriate identifiers, such as identifiers used for payment/user/device authentication or identification. In one embodiment, identifiers in database 116 may be used by user device 110, merchant device 130, and/or payment provider server 140, to associate user device 110 with a particular account maintained by payment provider server 140.

Database 116 may include user personal information (e.g. a name, social security number, user financial information, or other identifying information), a user account identifier (e.g. user account identifier is at least one of a user identifier, a user credit or debit card number, a user account name, and a user account number), and/or a user device identifier. In various embodiments, database 116 may include online account access information. Database 116 may also store user merchant information, including an identifier for merchant device 130. Database 116 may include transaction histories usable to present proof of purchase or merchant device 130.

In various embodiments, user device 110 includes at least one network interface component 118 adapted to communicate with merchant device 130 and/or payment provider server 140. Network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 118 may include a communication module for short range communications with merchant device 130 including microwave, radio frequency, infrared, Bluetooth, and near field communication devices.

Discount card 120 is named to describe a type of discount card a merchant may offer a user for purchase of goods with the merchant. Thus, discount card 120 may correspond to a “loyalty,” “reward,” coupon, gift card, or other type of discount identifier provided by a merchant. In other embodiments, other types of discount cards may correspond to a rebate card at the merchant, a coupon with a merchant, and/or a gift card at the merchant. Discount card 120 may correspond to merchant device 130 and offer one or more item discounts during purchase of items with merchant device 130.

Discount card 120 may offer immediate savings for items (e.g. a discount on items user 102 wishes to purchase) or may correspond to discounts on future purchases (e.g. a “preferred/loyal” customer discount based on a number, amount, or cost of purchases). As previously discussed, discount card 120 includes discount card information identifying a merchant corresponding to merchant device 130. Additionally, discount card 120 may include information identifying user 102 and/or unique information to identify a customer account corresponding to user 102 and discount card 120. Thus, the discount card information may be transmitted to payment provider server 140 for identification of a merchant and/or unique identification of user 102.

Merchant device 130 may be maintained, for example, by a merchant or seller offering various items (e.g., goods, products, and/or services) for sale to user 102 through a merchant location. Generally, merchant device 130 may be maintained by anyone or any entity that receives money, which includes charities as well as retailers and restaurants. In this regard, merchant device 130 may include processing applications, which may be configured to interact with user device 110 and/or payment provider server 140 to facilitate the sale of products, goods, and/or services including exchange of payment requests and/or discount card information.

Merchant device 130 may be implemented using any appropriate hardware and software configured for wired and/or wireless communication with user device 110 and/or payment provider server 140. For example, in one embodiment, merchant device 130 may be implemented as a single or networked personal computer (PC), a smart phone, personal digital assistant (PDA), laptop computer, and/or other types of computing devices at a merchant location capable of transmitting and/or receiving data. Although a merchant device is shown, the merchant device may be managed or controlled by any suitable processing device including a merchant server. Although only one merchant device is shown, a plurality of merchant devices may be utilized.

Merchant device 130 includes a payment application 132 configured to provide a convenient interface to permit a salesperson to select, review, and sell items to user 102. For example, payment application 132 may be implemented as an application having a user interface enabling the user to buy products available at merchant device 130. Thus, payment application 132 may include an interface displaying user selected products for purchase, including product information, purchase price, and total purchase costs. In some embodiments, payment application 132 may correspond more generally to a web browser configured to view merchant information available over the Internet or access a website corresponding to products available from a merchant, for example, merchant inventory at separate locations. Thus, payment application 132 may also be utilized to access merchant websites and engage in online transactions.

Payment application 132 may be configured to communicate with user device 110 and/or payment provider server 140 to complete transactions for items, including receiving discount card 120, storing information for discount card 120 with payment provider server 140, and/or receiving discount card information from payment provider server 140. In this regard, on an initial purchase of items with merchant device 130, payment application 132 may create a payment request for items selected by user 102, receive (e.g. scan or otherwise input) discount card 120, and transmit a payment request and discount card information to user device 110 and/or payment provider server 140. If payment application transmits the payment request to user device 110, payment/wallet application 112 of user device 110 may present the payment request to the merchant along with a user account identifier and discount card information to payment provider server 140 as described above. However, in other embodiments, payment application 132 may transmit the merchant's payment request to payment provider server 140 with discount card information and a user account identifier received from user device 110.

User 102 may purchase one or more item(s) from merchant device 130 after the initial transaction with a merchant. Thus, payment application 132 may transmit a payment request (including merchant identification) to user device 110 and/or payment provider server 140. Where the payment request is transmitted to user device 110, user device 110 may present the payment request and a user account identifier to payment provider server 140 for completion of the transaction. However, in other embodiments, merchant device 130 may receive the user account identifier from user device 110 and transmit the payment request and user account identifier to payment provider server 140. Payment provider server 140 may identify the user account through the user account identifier and the discount card information for merchant device 130 through the payment request to the merchant. Thus, payment provider server 140 may transmit the discount card information to user device 110 and/or merchant device 130 for use with the transaction, or may determine a reduced price of a payment for the payment request using the discount card and transmit a payment to user device 110 and/or merchant device 130.

In various embodiments, merchant device 130 includes at least one network interface component 134 adapted to communicate with user device 110 and/or payment provider server 140. Network interface component 134 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 134 may include a communication module for short range communications with user device 110 including microwave, radio frequency, infrared, Bluetooth, and near field communication devices.

Payment provider server 140 may be maintained, for example, by an online payment service provider, which may provide payment services to user 102. In this regard, payment provider server 140 includes one or more processing applications, which may provide payment for items between user device 110 and merchant device 130. In one example, payment provider server 140 may be provided by PayPal®, Inc. of San Jose, Calif., USA. However, in other embodiments, payment provider server 140 may be maintained by or include a merchant, financial services provider, and/or other service provider, which may provide user account and payment service to user 102. Although payment provider server 140 is described as separate from a merchant and/or merchant server corresponding to merchant device 130, it is understood that a merchant may include services offered by payment provider server 140.

Payment provider server 140 of FIG. 1 includes an account management application 150, a transaction processing application 142, other applications 144, a database 146, and a network interface component 148. Account management application 150, transaction processing application 142, and other applications 144 may correspond to processes, procedures, and/or applications executable by a hardware processor, for example, a software program. In other embodiments, payment provider server 140 may include additional or different software as required.

Account management application 150 may enable user 102 to establish a user account with payment provider server 140 and maintain the user account, including storing discount card information with the user account. In this regard, account management application 150 may receive information from user 102 to establish a user account. Information may include user personal information, user financial information, and user account identifiers, such as a user identifier, a user device identifier, a user credit or debit card number, a user account name, and/or a user account number.

After establishment of the user account, user 102 may utilize account management application 150 to maintain the user account. User 102 may log in to the user account and use account management application 150 to store additional information with the user account including discount card information. However, in other embodiments, account management application 150 may receive the discount card information from user device 110 and/or merchant device 130 during completion of a payment request. Account management application 150 may store the discount card information with the user account.

Transaction processing application 142 may be configured to receive information from user device 110 and/or merchant device 130 for processing and completion of financial transactions. Transaction processing application 142 may include one or more applications to process financial transaction information from user device 110 and/or merchant device 130. Transaction processing application 142 may receive a payment request to complete a sale transaction for an item. Transaction processing application 142 may complete the sale transaction by providing payment to merchant device 130. In other embodiments, transaction processing application 142 may provide transaction histories, including receipts, to user device 110 in order to provide proof or purchase to merchant device 130 and complete the financial transaction.

Payment requests received by transaction processing application 142 may include a reduced purchase price corresponding to a use of discount card 120. Thus, transaction processing application 142 may provide payment for the payment request alone. However, in other embodiments, transaction processing application 142 may utilize discount card information stored with a user account to determine a reduced purchase price for a payment request. Transaction processing application 142 may then provide payment for the reduced price of the payment request to user device 110 and/or payment provider server 140.

In various embodiments, payment provider server 140 includes other applications 144 as may be desired in particular embodiments to provide features to payment provider server 140. For example, other applications 144 may include security applications for implementing server-side security features, programmatic server applications for interfacing with appropriate application programming interfaces (APIs) over network 160, or other types of applications. Other applications 144 may contain software programs, executable by a processor, including a graphical user interface (GUI), configured to provide an interface to a user.

Additionally, payment provider server 140 includes database 146. As previously discussed, user 102 may establish one or more user accounts with payment provider server 140. User accounts in database 146 may include user information, such as name, address, birthdate, payment/funding information, additional user financial information, and/or other desired user data. User 102 may link user accounts to user device 110 through a user device identifier. Thus, when a device identifier corresponding to user device 110 is transmitted to payment provider server 140, e.g. from user device 110 and/or merchant device 130, a user account belonging to user 102 may be found. In other embodiments, user 102 may not have previously established a user account and may utilize account management application 150 to create one.

In various embodiments, payment provider server 140 includes at least one network interface component (NIC) 148 adapted to communicate with network 160 including user device 110 and/or merchant device 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

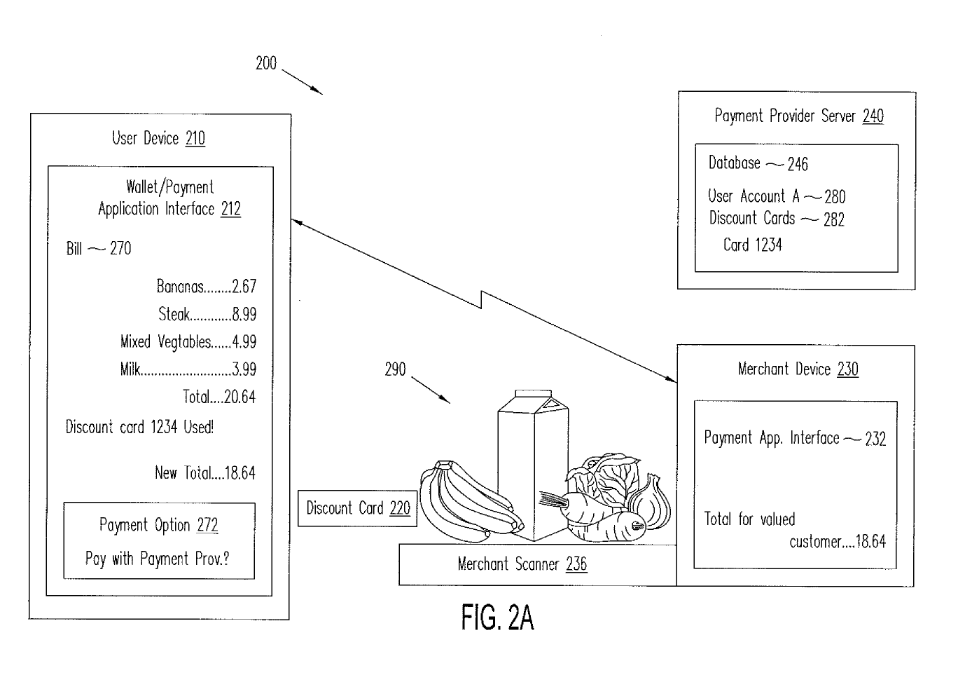

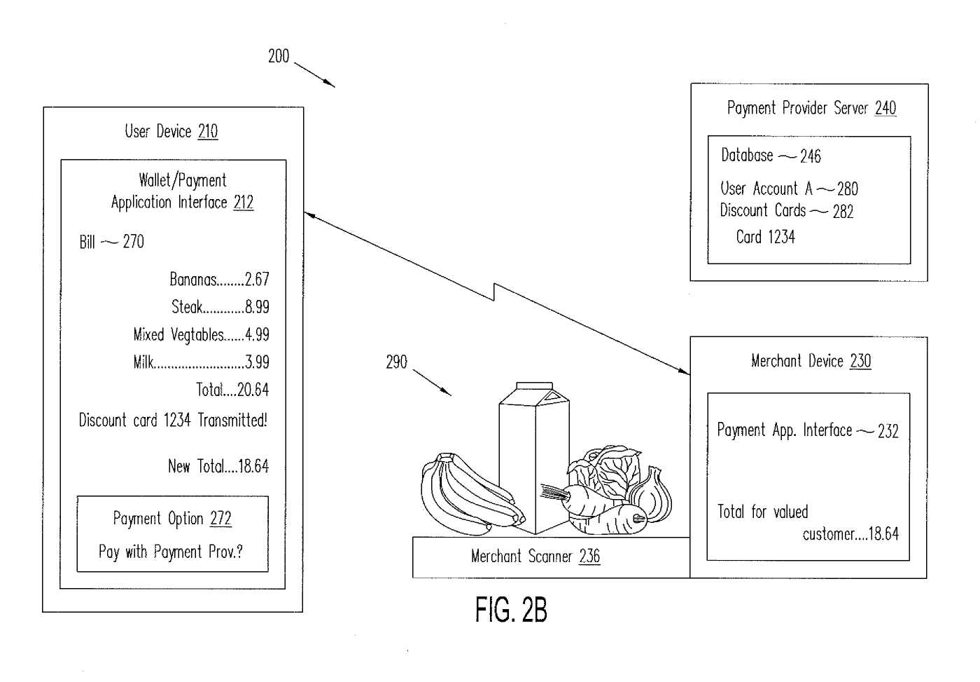

FIG. 2A is an exemplary system for storing a user discount card with a payment account for future purchases, according to an embodiment. Environment 200 of FIG. 2A includes user device 210, merchant device 230, and payment provider server 240 corresponding generally to user device 110, merchant device 130, and payment provider server 140, respectively, of FIG. 1. Additionally, wallet/payment application interface 212, payment application interface 232, and database 246 of FIG. 2A may display processes corresponding generally to the described functions of wallet/payment application 112, payment application 132, and database 146, respectively, of FIG. 1.

In environment 200, a user (not shown) in engaged in a transaction to purchase items 290. Items 290 have been scanned to merchant device 230 using merchant scanner 236. Additionally, the user has presented discount card 220 with items 290 to receive a “valued customer” discount or other available discount from discount card 220. In other embodiments, another identifier allowing merchant device 230 to recall discount card information for discount card 220 may be provided (e.g. a phone number linked to discount card 220).

Payment application interface 232 displays a total for a “valued customer” of $18.64 for items 290. Merchant device 230 may create a payment for items 290, where the payment identifies the merchant corresponding to merchant device 130 and a price for purchase of items 290. The payment may correspond to a reduced price for items 290 using discount card 220. Additionally, discount card information for discount card 220 may be transmitted to user device 210. However, in various embodiments, discount card information may be entered to user device 210 (e.g. a discount card number or a phone number linked to discount card 210) and transmitted to merchant device 230.

User device 210 may be in communication with merchant device 230. Wallet/payment application interface 212 of user device 210 may display bill 270 corresponding to the payment. As shown in FIG. 2, bill 270 displays items 290, an original purchase prices without discount card 220, discount card information for discount card 220, and a reduced purchase price for a “valued customer.” In various embodiments, wallet/payment application interface 212 may display further information, such as a merchant identification, various stored credit/debit cards, or other information to complete a financial transaction for items 290. Thus, bill 270 of wallet/payment application interface 212 displays a total for items 290 of $18.64. Wallet/payment application interface 212 also displays payment option 272. Payment option 272 may display to the user “Pay with Payment Prov.?” and enable a process or procedure to complete payment for items 290 using payment provider server 240.

Selecting payment option 272 may initiate a process to complete payment for items 290 using payment provider server 240. In various embodiments, user device 210 may generate a payment request including the payment to the merchant and a user account identifier and transmit the payment request and discount card information to payment provider server 240. The payment account identifier may enable payment provider server 240 to locate an account for payment. However, in other embodiments, selection of payment options 272 may cause user device 210 to transmit a user account identifier to merchant device 230. Thus, merchant device 230 may transmit the discount card information and payment request including a user account identifier to payment provider server 240.

Payment provider server 240 may then complete the payment request and transmit a payment to user device 210 and/or merchant device 230. The payment may include a transaction history proving proof of payment, which may be transmitted to the other device to complete the transaction. For example, user device 210 may receive the payment and transmit the payment to merchant device 230 with a transaction history proving payment. In another embodiment, merchant device 230 may receive the payment and display a transaction history to a user of user device 210 to prove receipt of payment to the user.

In addition to providing payment services for the payment request, payment provider server 240 includes database 246 storing user account A 280 and discount cards 282. Discount cards 282 includes the same “discount card 1234” information as discount card 220. Thus, payment provider server 240 may store discount card information for discount card 220 in database 246 for future transactions.

FIG. 2B is an exemplary system showing transmission of a stored user discount card to a merchant for use with a purchase, according to an embodiment. As previously discussed in reference to FIG. 2A, environment 200 of FIG. 2B includes user device 210, merchant device 230, and payment provider server 240 corresponding generally to user device 110, merchant device 130, and payment provider server 140, respectively, of FIG. 1. Additionally, wallet/payment application interface 212, payment application interface 232, and database 246 of FIG. 2B may display processes corresponding generally to the described functions of wallet/payment application 112, payment application 132, and database 146, respectively, of FIG. 1.

Environment 200 of FIG. 2B displays a transaction similar to FIG. 2A for items 290, however, a user purchasing items 290 has not brought a discount card for the items to the merchant location of environment 200. Thus, environment 200 does not display discount card 220 of FIG. 2A.

However, in the embodiment of FIG. 2B, user device 210 and/or merchant device 230 may generate a payment request including a payment to a merchant (i.e. a merchant corresponding to merchant device 230) and a user account identifier, as discussed in reference to FIG. 2A. User device 210 and/or merchant device 230 may transmit the payment request to payment provider server 240. In contrast to FIG. 2A, payment provider server 240 has already stored “card 1234” with user account A 280 under discount cards 282. Since the payment request includes a payment identifying the merchant, payment provider server 240 may locate the discount card, “card 1234,” and use discount card with the purchase request. In certain embodiments, payment provider server 240 may transmit the discount card to user device 210 and/or merchant device 230 to complete a reduced price for the payment to the merchant. Thus, user device 210 and/or merchant device 230 may transmit a new payment request to payment provider server 240 after the reduced price of the payment is calculated. However, in other embodiments, payment provider server 240 may calculate the reduced price of the payment and transmit a payment in the amount of the reduced price to user device 210 and/or merchant device 230.

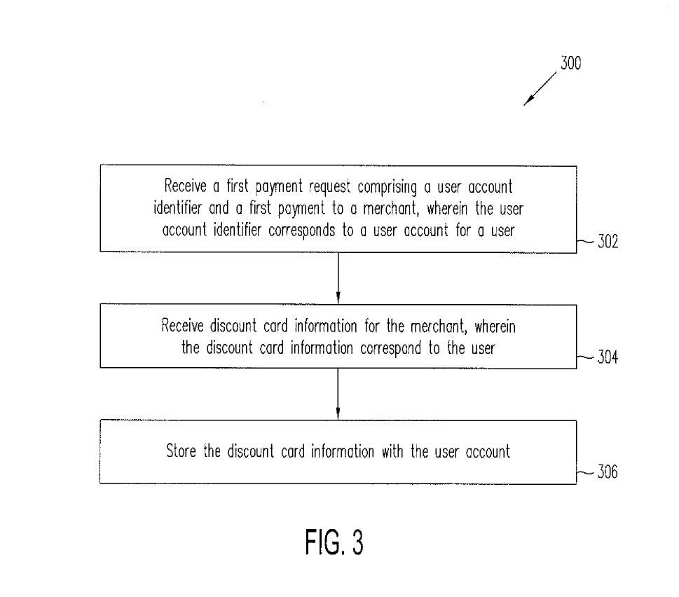

FIG. 3 is a flowchart of an exemplary process for storing user discount cards with a payment account for future purchases, according to an embodiment. Note that one or more steps, processes, and methods described herein may be omitted, performed in a different sequence, or combined as desired or appropriate.

At step 302, a first payment request comprising a user account identifier and a first payment to a merchant is received, wherein the user account identifier corresponds to a user account for a user. A payment provider may receive the first payment request in order to provide payment for items to the merchant. Thus, the user account may correspond to a payment account with the payment provider. However, in other embodiments, the first payment request may be received by another entity providing user account services to the user. The payment may further include a reduced price for the items based on a discount card presented to the merchant. The payment request may be received from a user device and/or from a merchant device.

The user account identifier may correspond to information enabling identification of a user account. Thus, the user account identifier may include a name/number string enabling identification of the user account. However, the user account identifier may also correspond to unique information of the user and stored with the user account. Thus, the user account identifier may be a user identifier, a user credit or debit card number, a user account name, and/or a user account number.

Discount card information for the merchant may be received, at step 304, wherein the discount card information corresponds to the user. The discount card information may be unique to the user, such as a savings, store credit, or other reward card for only the specific user. However, in other embodiments, the discount card information may not be unique to the user and provide general benefits for the user while shopping at the merchant. The discount card information may correspond to a loyalty card at the merchant, a rebate card at the merchant, and a gift card at the merchant.

At step 306, the discount card information is stored with the user account. The discount card information may be stored for use in future purchases. Additionally, the payment provider may complete the first payment with the merchant by providing a monetary payment to the user device and/or the merchant device.

The payment provider may receive a second payment request from a user device and/or a merchant device, where the second payment request comprises the user account identifier and a second payment to the merchant. Based on the received payment request, the payment provider may transmit the discount card information to the user device and/or the merchant device for use with the transaction. Thus, the user device and/or the merchant device may determine a reduced price for the second payment using the discount card information and complete a monetary payment in the amount of the reduced price of the second payment with the merchant. However, in other embodiments, the payment provider may determine a third payment corresponding to the reduced price of the second payment using the discount card, and complete the third payment with the merchant.

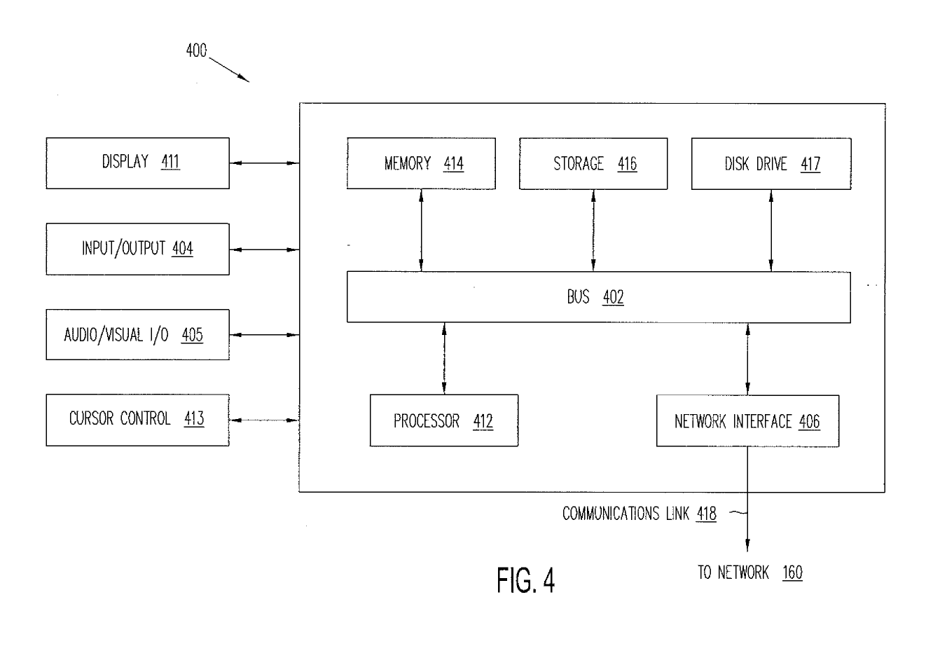

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common faints of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account info illation comprising a user account for a user; and
one or more hardware processors in communication with the non-transitory memory and configured to:
receive a first payment request comprising a user account identifier and a first payment to a merchant, wherein the user account identifier corresponds to the user account for the user;
receive discount card information for the merchant, wherein the discount card information corresponds to the user; and
store the discount card information with the user account.

2. The system of claim 1, wherein the one or more hardware processors is further configured to:
receive a second payment request comprising the user account identifier and a second payment to the merchant; and
transmit the discount card information to at least one of the merchant and the user.

3. The system of claim 2, wherein the one or more hardware processors is further configured to:
determine a third payment comprising a reduced price of the second payment using the discount card information; and
complete the third payment with the merchant.

4. The system of claim 1, wherein the one or more hardware processors is further configured to:
complete the first payment comprising a reduced price of at least one item using the discount card information with the merchant.

5. The system of claim 1, wherein the discount card information is at least one of a loyalty card at the merchant, a rebate card at the merchant, and a gift card at the merchant.

6. The system of claim 1, wherein the user account identifier is at least one of a user identifier, a user credit or debit card number, a user account name, and a user account number.

7. The system of claim 1, wherein the first payment request and the discount card information are received from one of a user device of the user and a merchant device of the merchant.

8. The system of claim 1, wherein the user account corresponds to a payment account with a payment provider.

9. A method comprising:
receiving a first payment request comprising a user account identifier and a first payment to a merchant, wherein the user account identifier corresponds to a user account for a user;
receiving discount card information for the merchant, wherein the discount card information corresponds to the user; and
storing, using one or more hardware processors of a server, the discount card information with the user account.

10. The method of claim 9 further comprising:
receiving a second payment request comprising the user account identifier and a second payment to the merchant; and
transmitting the discount card information to at least one of the merchant and the user.

11. The method of claim 10 further comprising:
determining a third payment comprising a reduced price of the second payment using the discount card information; and
completing the third payment with the merchant.

12. The method of claim 9 further comprising:
completing the first payment comprising a reduced price of at least one item using the discount card information with the merchant.

13. The method of claim 9, wherein the discount card information is at least one of a loyalty card at the merchant, a rebate card at the merchant, and a gift card at the merchant.

14. The method of claim 9, wherein the user account identifier is at least one of a user identifier, a user credit or debit card number, a user account name, and a user account number.

15. The method of claim 9, wherein the first payment request and the discount card information are received from one of a user device of the user and a merchant device of the merchant.

16. The method of claim 9, wherein the user account corresponds to a payment account with a payment provider.

17. A non-transitory computer readable medium comprising a plurality of machine-readable instructions which when executed by one or more processors of a server are adapted to cause the server to perform a method comprising:
receiving discount card information for a merchant, wherein the discount card information corresponds to a user;
storing the discount card information with a user account for the user;
receiving a first payment request comprising a user account identifier corresponding to the user account and a first payment to the merchant; and
transmitting the discount card information to at least one of the merchant and the user.

18. The non-transitory computer readable medium of claim 17, wherein the method further comprising:
determining a second payment comprising a reduced price of the first payment using the discount card information; and
completing the second payment with the merchant.

19. The non-transitory computer readable medium of claim 17, wherein the discount card information is at least one of a loyalty card at the merchant, a rebate card at the merchant, and a gift card at the merchant.

20. The non-transitory computer readable medium of claim 17, wherein the discount card information is received with an initial payment request comprising the user account identifier and an initial payment to a merchant.
